(19) United States
(12) Patent Application Publication
(10) Pub. No.: US 2025/0196644 A1
(43) Pub. Date: Jun. 19, 2025

(54) DISPLAY CONTROL DEVICE, DISPLAY SYSTEM, AND DISPLAY CONTROL METHOD

(71) Applicant: Nippon Seiki Co., Ltd., Niigata (JP)

(72) Inventor: Ryo TAKANO, Niigata (JP)

(21) Appl. No.: 18/849,663

(22) PCT Filed: Apr. 26, 2023
(86) PCT No.: PCT/JP2023/016431

§ 371 Date: Sep. 23, 2024

(30) Foreign Application Priority Data
Apr. 27, 2022 (JP) 2022-073631

(51) Int. Cl. B60K 35/81; B60K 35/22; B60K 35/232; B60K 35/26; B60K 35/28; B60K 35/29; B60W 50/14; G08G 1/16

(52) U.S. Cl. CPC B60K 35/81; B60K 35/22; B60K 35/265; B60K 35/28; B60K 35/29; B60W 50/14; G08G 1/16; B60K 35/232; B60K 2360/172; B60W 2050/146

(57) ABSTRACT

A display control device has a control unit that controls image display on multiple display units. The multiple display units comprise a first display unit for displaying a first image and a second display unit for displaying a second image. In the case of displaying driving-change notification information to notify an occupant of a vehicle that the vehicle is to change from a first driving condition to a second driving condition, while the occupant is viewing the first image in the first display unit, the control unit executes a first display control process of causing to display driving-change notification information as a second image in the second display unit so as not to overlap the first image, and then executes a second display control process of causing to display said driving-change notification information in place of the first image in the first display unit.

### TECHNICAL FIELD

The present invention relates to a display control device, a display system, a display control method, and the like, provided in vehicles such as automobiles, for example.

### BACKGROUND ART

Paragraph [0040] in Patent Document 1 describes “in switching automatic driving to manual driving, to change the display on the internal display to specific display content and images, indicating switching to manual driving, so as to improve the driver's motivation for manual driving.”

### PRIOR ART DOCUMENT

### Patent Document

Patent Document 1: JP 2021-82354 A

### SUMMARY OF THE INVENTION

### Problems to be Solved by the Invention

When required to switch the vehicle from an automatic driving mode to a manual driving mode, an automatic driving system issues a request (i.e., takeover request: TOR) prompting the occupant, who is to be the driver during manual driving, to return to operation of the vehicle. Here, “takeover” is to transfer driving, and “takeover request” is, in other words, a request of transferring driving.

In the present specification, TOR is occasionally referred to as “driving switching request” which is to switch the driving state, and TOR is one type of “driving switching notification information” in a broad sense to notify switching of the driving state.

Here, assume a case in which, during automatic driving, it becomes necessary to issue TOR, in a state in which a map image or a video for entertainment is displayed on a windshield or a screen provided to cover a part of the windshield etc., for example.

In this case, when the display for automatic driving is abruptly switched to the display for TOR, the occupant to be the driver may be distressed.

It is considered possible to display both of the display for automatic driving and the display for TOR. However, in that case, the different type of images are displayed at a time, and therefore the occupant's feeling of discomfort is considered great.

In addition, the occupant may possibly desire to continue watching the image or video which he or she was watching during automatic driving. In that case, an act of forcibly ending the display for automatic driving and switching to the display for TOR could be said to be an act against the above-stated expectations of the occupant.

The stated problems were revealed by the investigation of the present inventors. The above-stated Patent Document 1 neither describe the stated problems nor does it mention the countermeasures against the stated problems.

An object of the present invention is to make the occupant recognize switching of the driving state without feeling any discomfort, while alleviating the occupant's feeling of distress or not going against the expectations of the occupant in switching of the driving state.

The other objects of the present invention will be apparent to those skilled in the art of the present invention by referring to the following embodiments and best modes, and the accompanying drawings.

### Solution to Problem

The following exemplifies aspects according to the present invention, for facilitating understanding of an outline of the present invention.

According to a first aspect of the present invention, a display control device includes: a control unit to control image display of a plurality of display units mounted on a vehicle, where the plurality of display units include a first display unit to display a first image and a second display unit to display a second image, and in displaying driving switching notification information for notifying an occupant of the vehicle of switching of the vehicle from a first driving state to a second driving state, in a state in which the occupant watches the first image on the first display unit, the control unit performs: a first display control process of causing the second display unit to display the driving switching notification information, being the second image, so as not to overlap with the first image; and thereafter a second display control process of causing the first display unit to display the driving switching notification information instead of the first image.

In the first aspect, in switching of the driving state, instead of abruptly displaying the driving switching notification information in place of the first image which the occupant is watching, the driving switching notification information is displayed not to overlap with the first image, to begin with. By doing so, the occupant can recognize the driving switching notification information around his or her field of view while watching the first image. Therefore, necessity of switching of the driving state can be notified, i.e., preliminary announced, to the occupant without making the occupant feel any discomfort.

Thereafter, the driving switching notification information is transitioned to the position at which the first image used to be displayed. This assuredly notifies the occupant of detailed content of driving switching and switching timing, etc., for example. As a result, the occupant can visually confirm the driving switching notification information without looking away from the first image, which alleviates the occupant's burden.

According to the present aspect, in switching of the driving state, the occupant's feeling of distress is alleviated and the occupant is made to recognize switching of the driving state without feeling any discomfort.

According to a second aspect according to the first aspect, a configuration is possible in which the first display unit is a projection-type display device to project display light of an image onto a windshield of the vehicle or a screen provided to cover at least a part of the windshield, the second display unit is a display tool apparatus to display an image on a display screen, and the control unit performs the first and second display control processes prior to expiry of a driving state switching period.

According to the second aspect, one preferable example, for which the display control according to the present invention is effective, is exhibited. For example, in such a case where the automatic driving state is switched to the manual driving state in response to ending of an automatic driving segment, for example, notification by the driving switching notification information may be performed prior to expiry of the switching period of the driving state, and there may well be the case where there is comparatively a long time before the expiry of the switching period.

In the automatic driving segment, such a case may be considered in which an entertainment image, a map image, or the like, is displayed in the position where the occupant looks in front, i.e., the position where the occupant looks straight ahead, or in the vicinity thereof, and the occupant is visually confirming these images.

The mentioned display can be realized by display using a projection-type display device such as a head-up display (HUD), which projects an image on a windshield or a screen covering a part of the windshield, for example. In this case, the driving switching notification information can be displayed larger, for example, at the substantially front position as viewed from the occupant, which realizes an easy-to-view display.

On the other hand, in many cases, a vehicle is provided with such a display device as a center information display (CID), which is either embedded in the dashboard or provided upright on the dashboard, for example, in addition to the HUD device, or the like. The CID, or the like, is provided in the vicinity of the occupant in many cases. Therefore, while watching an image displayed on the HUD, or the like, the occupant can grasp an image displayed on the CID, or the like, in the periphery of the field of view.

With this in view, a first-type display device of projection type, which projects an image, such as the HUD, and a second-type display device of screen display type, which directly displays an image on a screen, such as the CID, are linked together, and the driving switching notification information is first displayed on the display device of screen display type. In this case, while watching the first image, the occupant can notice that the driving switching notification information is presented in the periphery of his or her field of view and indirectly understand that switching of the driving state is to be performed.

Thereafter, the HUD, or the like, displays the driving switching notification information, and displays the driving switching notification information in place of the first image. By doing so, the occupant can directly visually confirm the driving switching notification information on the easy-to-view display without looking away, which allows the occupant to assuredly recognize and confirm the content, timing, etc. of driving switching.

In this way, by cooperative control by way of linking together a plurality of display devices, i.e., a plurality of display units, in switching of the driving state, the occupant's feeling of distress is alleviated, and the occupant can be made to recognize switching of the driving state without feeling any discomfort.

According to a third aspect according to the first aspect or the second aspect, a configuration is possible in which if the first image is predetermined continuous content which is expected to be desired by the occupant to continuously watch, or continuously set content set in advance as content desired to be continuously watched by the occupant, the control unit performs, concurrently with the second display control process, a third display control process of causing the first image to be displayed as the second image on the second display unit.

According to the third aspect, if the first image which the occupant was watching is predetermined continuous content or continuously set content, the third display control process is performed in which, even after the driving switching notification information is displayed in place of the first image, the first image is transitioned to the second display unit so that the occupant can continuously watch the first image by occasionally looking away.

The third display control is performed concurrently with the second display control. As a result, the display of the first image and the display of the driving switching notification information are swapped. Because the first image is continuously displayed in the second display unit, the occupant can continuously watch the first image at an appropriate timing. In addition, because the first image and the image about the driving switching notification information are swapped, it does not take time, and the occupant experiences no visual discomfort but only minimal psychological burden.

In this way, according to the present aspect, in switching of the driving state, the occupant can be made to recognize switching of the driving state without feeling any discomfort while making sure not going against the expectations of the occupant.

According to a fourth aspect according to the first aspect or the second aspect, a configuration is possible in which if the first image is neither predetermined continuous content which is expected to be desired by the occupant to continuously watch, nor continuously set content set in advance as content desired to be continuously watched by the occupant, the control unit performs a fourth display control process of causing the second display unit to display, again, content which the second display unit used to display prior to displaying the driving switching notification information.

According to the fourth aspect, when the second display control of displaying the first image on the second display unit is not performed, the image which used to be displayed prior to displaying of the driving switching notification information is displayed again on the second display unit. Accordingly, the image, the display of which was discontinued by the presentation of the driving switching notification information, can be watched again. The occupant can obtain useful information again from that image.

According to a fifth aspect according to the first aspect or the second aspect, a configuration is possible in which if the first image is neither predetermined continuous content which is expected to be desired by the occupant to continuously watch, nor continuously set content set in advance as content desired to be continuously watched by the occupant, the control unit performs a fifth display control process in which a content selection image is displayed on the second display unit, and if content is selected using the content selection image within a predetermined period, the selected content is displayed on the second display unit.

According to the fifth aspect, when the second display control of displaying the first image on the second display unit is not performed, the content selection image is displayed on the second display unit.

Accordingly, content to be displayed on the second display unit can be selected by the occupant. When the occupant has selected content within a predetermined period, for example within a driving switching period, the selected content is displayed on the second display unit. Accordingly, the occupant can watch a content image which the occupant prefers, which improves the usability.

According to a sixth aspect according to the fifth aspect, a configuration is possible in which if the content is not selected within the predetermined period, the control unit performs a sixth display control process of maintaining the content selection image even after the predetermined period.

According to the sixth aspect, if no content selection is performed within a predetermined period, for example within a driving switching period, the display of the content selection image is maintained on the second display unit even after the elapse of the predetermined period. Accordingly, the occupant can select content to be displayed on the second display unit even after the elapse of the predetermined period, which improves the usability.

According to a seventh aspect according to any one of the first to sixth aspects, a configuration is possible in which if there is an other display unit in addition to the first and second display units, the control unit performs a seventh display control process of performing either: decreasing visual attraction by lowering luminance, chroma, or brightness of display in the other display unit during a period in which the first and second display control processes are being performed; decreasing visual attraction by providing a translucent mask on a display image surface; hiding the display; or displaying an auxiliary image which indicates driving state switching.

According to the seventh aspect, for example during a period in which the second and third display control processes are being performed, for any other display unit other than the display unit on which the display is changed, for example any of the following control may be performed: the luminance, chroma, or brightness of the display is lowered to a predetermined value; a translucent black mask is provided on the display screen; the display is turned off; an auxiliary image, such as texts or animation, which indicates switching of the driving state, is displayed, so as to make the occupant focus on the display unit on which the display is changed.

Accordingly, the occupant is prevented from being distracted and can focus on the content subject to display switch, which ensures reliable presentation of information.

According to an eighth aspect according to any one of the first to seventh aspects, a configuration is possible in which, as a method of disappearance of an image and a method of appearance of an image in a display switching period, the control unit performs, on at least one of the first and second display units, any of: an instantaneous image disappearance and appearance process; a disappearance and appearance process using fade-out and fade-in to change luminance over time; or a disappearance and appearance process involving a highlighting process by way of flashing of an image or change of a display mode.

According to the eighth aspect, by devising the method of disappearance and appearance of an image during switching of a display, visual attraction can be enhanced. This helps the occupant focus on the display unit on which the display is changed, for example.

According to a ninth aspect according to any one of the first to eighth aspects, a configuration is possible in which the display unit is any display device from among a head-up display (HUD) device, a meter display, a direct projection display for projection of an image displayed on a display onto a windshield or a screen without use of an optical system, a center information display (CID), a center console monitor, a wide display, a passenger display, a display mirror, a side monitor, and an in-vehicle projector projecting an image inside the vehicle.

According to the ninth aspect, by using various types of display units, i.e., display devices, included in the vehicle, the above-described various types of display control processes can be effectively performed without addition of any special display device.

According to a tenth aspect according to any one of the first to ninth aspects, a configuration is possible in which when a single display device includes a plurality of display areas whose display is separably controllable, the control unit performs the first and second display control processes by deeming each single display area as a single display unit.

According to the tenth aspect, when a single display device, i.e., the display device, includes a plurality of display areas whose display is separably controllable, the above-described various controls may be performed by deeming that there is a display unit for each display area. By doing so, the number of usable display units can be substantially increased.

In other words, by deeming that there is a display unit for each display area, the number of selectable display units increases, thereby allowing an optimal display unit to be selected and used. Accordingly, the visual effect for the occupant can enhance.

According to an eleventh aspect according to any one of the first to sixth aspects, and the eighth to tenth aspects, a configuration is possible in which the control unit performs, in the second display control process, a display moving process of moving the driving switching notification information over time, and thereafter transitioning the driving switching notification information to the first display unit.

According to the eleventh aspect, for example in switching display content in the first and second display units, display switching control accompanying moving is performed, for example, by performing switching by moving the display via the third display unit, by moving the display position in the display unit having a laterally long display screen, or by moving the display position by moving the movable display unit. Accordingly, it is possible to impress on the occupant the change in the display content, for example, which ensures more reliable presentation of information.

A display system according to the present invention includes a plurality of display units mounted on a vehicle; and the control unit according to any one of the first to eleventh aspects.

As a result, a display system, i.e., an in-vehicle display system, can be realized, which can make the occupant recognize switching of the driving state without feeling any discomfort, while alleviating the occupant's feeling of distress or not going against the expectations of the occupant in switching of the driving state.

A display control method according to the present invention is a display control method of controlling image display of a plurality of display units mounted of a vehicle, the plurality of display units including a first display unit to display a first image and a second display unit to display a second image, and in displaying driving switching notification information for notifying an occupant of the vehicle of switching of the vehicle from a first driving state to a second driving state, in a state in which the occupant watches the first image on the first display unit, the display control method including: a step of performing a first display control process of causing the second display unit to display the driving switching notification information, being the second image, so as not to overlap with the first image; and thereafter a step of performing a second display control process of transitioning the driving switching notification information to the first display unit, and displaying the driving switching notification information instead of the first image.

According to the above, in switching of the driving state, the occupant's feeling of distress is alleviated, and the occupant can be made to assuredly recognize switching of the driving state and without feeling any discomfort.

Those skilled in the art of the present invention can easily understand that the exemplified embodiments according to the present invention can be further modified without departing from the gist of the present invention.

### BRIEF DESCRIPTION OF THE DRAWINGS

FIG. 1 illustrates an exemplary configuration of a driving assistance system (automatic driving system), a vehicular display system, and a display control device.

FIG. 2 illustrates an example of a display unit (display device) usable in the present invention.

FIG. 3 illustrates exemplary first to fourth display control processes.

FIG. 4 illustrates exemplary fifth and sixth display control processes.

FIG. 5 illustrates an exemplary seventh display control process.

FIG. 6 illustrates an exemplary display in a case where fade-out and fade-in are used as a method of disappearance and appearance of an image, during switching of a display.

FIG. 7 illustrates an exemplary display in a case where a highlighting display system is used as a method of disappearance and appearance of an image, during switching of a display.

FIG. 8 is a flowchart illustrating an example of display control in response to a driving switching request.

FIG. 9 is a flowchart illustrating an other example of display control in response to a driving switching request.

FIG. 10 illustrates a concrete example of display control in a vehicle traveling along a highway.

### MODE FOR CARRYING OUT THE INVENTION

The best mode described below is intended to facilitate understanding of the present invention. Therefore, those skilled in the art of the invention should note that the present invention is not unfairly limited by the embodiments described below.

It should be noted that, in the following description, each of various types of display devices is occasionally referred to as “display unit”. In addition, such a display device as a liquid crystal panel which can display a real image on a display screen is occasionally referred to as a “display tool” or “display tool apparatus”.

In addition, in the following description, the term “driving switching request” is used, which is meant to be interpreted in a broad sense. For example, the automatic driving system may issue a driving switching request when switching the level of automatic driving, not only when switching from the automatic driving state to the manual driving state.

In addition, the “driving switching notification information” issued by a system mounted on a vehicle when the driving state is switched is preferably interpreted in the broadest sense. For example, examples of a first driving state and a second driving state are a stop state and a traveling state. When a vehicle is stopped at the red light, the timing at which the red light changes to the blue light may be detected by inter-vehicle communication, and the later-described display control process may be performed by that detected timing. In a different example in which the vehicle mounts thereon a cruise control function, the first driving state and the second driving state may be a set-speed traveling state and a normal traveling state, and the later-described display control process may be performed predicting a braking operation because the set-speed traveling state is unable to be maintained due to the heaviness of the surrounding traffic. In addition, an adaptive cruise control (ACC) mounted car may set the first driving state and the second driving state to an ACC traveling state and a normal traveling state, and may convey, to the driver, a request to switch to manual driving and perform the later-described display control process when, for example, the own vehicle has determined that it is difficult to adjust the speed by way of a camera due to a climate effect. In the following description, mainly the case in which the automatic driving state is transitioned to the manual driving state is described.

A typical known display device to project an image (or display light of an image) onto a projected member such as a windshield is a head-up display (HUD) device.

The HUD device projects an image via a catoptric system such as a concave mirror. However, there is also a type of display device which eliminates this catoptric system and projects the image displayed on the display screen as it is onto the projected member. In the present specification, this type of display device is referred to as a direct projection display or a windshield display (WSD) for the purpose of convenience, and is distinguished from the HUD device.

In addition, a projector that projects display light of an image onto a steering wheel, or the like, can also be used as a projection-type display device (display unit). In the present specification, such a projector as being mounted in a vehicle and not only serving as interior decoration but also capable of presenting information is referred to as “in-vehicle projector”.

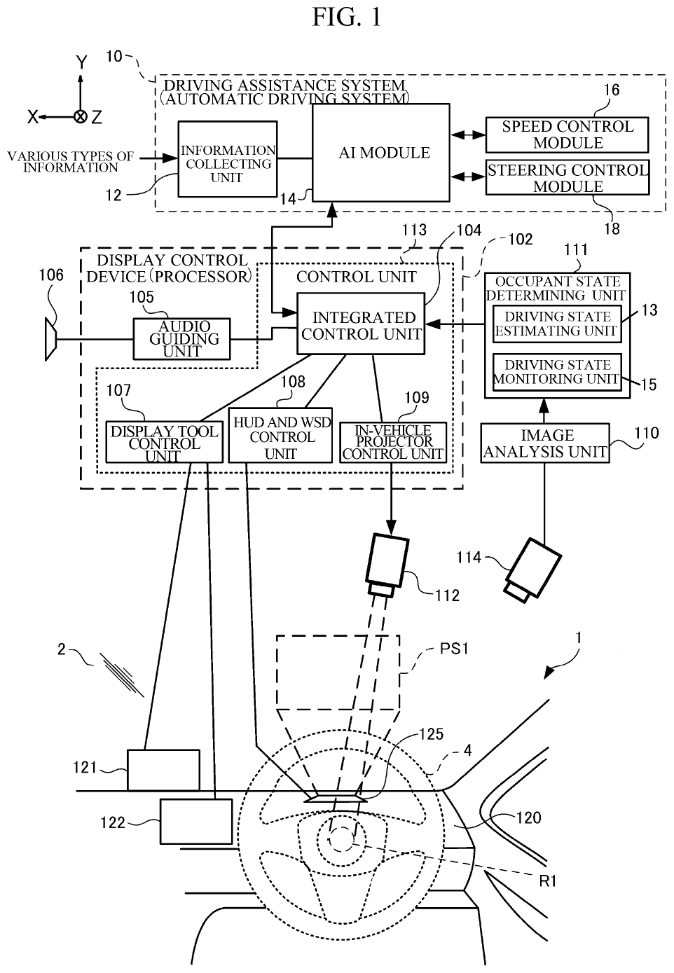

The following refers to FIG. 1. FIG. 1 illustrates an exemplary configuration of a driving assistance system (automatic driving system), a vehicular display system, and a display control device. Note that, in FIG. 1, a width direction of a vehicle (a left-right direction when viewed from the driver) is referred to as X-direction, a height direction of the vehicle is referred to as Y-direction, and a front direction when viewed from the driver is referred to as Z-direction.

The driving assistance system (automatic driving system) 10 includes an information collecting unit 12 to collect various types of information from an electronic control unit (ECU), or the like, an AI module 14, a speed control module 16, and a steering control module 18.

The display system includes a display control device (processor) 102, a speaker (audio output unit) 106, an image analysis unit 110, an occupant state determining unit 111, in-vehicle projector 112, an image-capturing camera 114 to capture an image of the occupant (driver, etc.) of the vehicle 1, a center console monitor 121, center information display (CID) 122, and a head-up display (HUD) device 125.

Note that the occupant state determining unit 111 of the occupant includes a driving state estimating unit 13, and a driving state monitoring unit 15.

The HUD device 125 projects an image onto the windshield 2 (or a transparent or translucent screen, etc., provided to cover the windshield 2), thereby being able to display an imaginary image (image) on a virtual imaginary display surface PS1 set in a space in the front, which is for example distanced from a viewpoint position of the occupant by a predetermined distance. The same thing applies to the WSD.

The center information display (CID) 122 and the HUD device 125 are provided for the dashboard 120, and the center console monitor 121 is provided above the dashboard 120.

The in-vehicle projector 112 projects an image R1 onto the steering wheel 4, for example, thereby being able to present necessary information. However, this is merely an example, and the in-vehicle projector 112 may project an image on the dashboard 120 or the windshield 2, or on a screen provided to cover the windshield 2 (not illustrated), etc. The display control device (processor) 102 includes a control unit 113 to control display modes of various types of display units and the audio guiding unit 105.

The control unit 113 includes an integrated control unit 104, a display tool control unit 107, an HUD and WSD control unit 108, and an in-vehicle projector control unit 109.

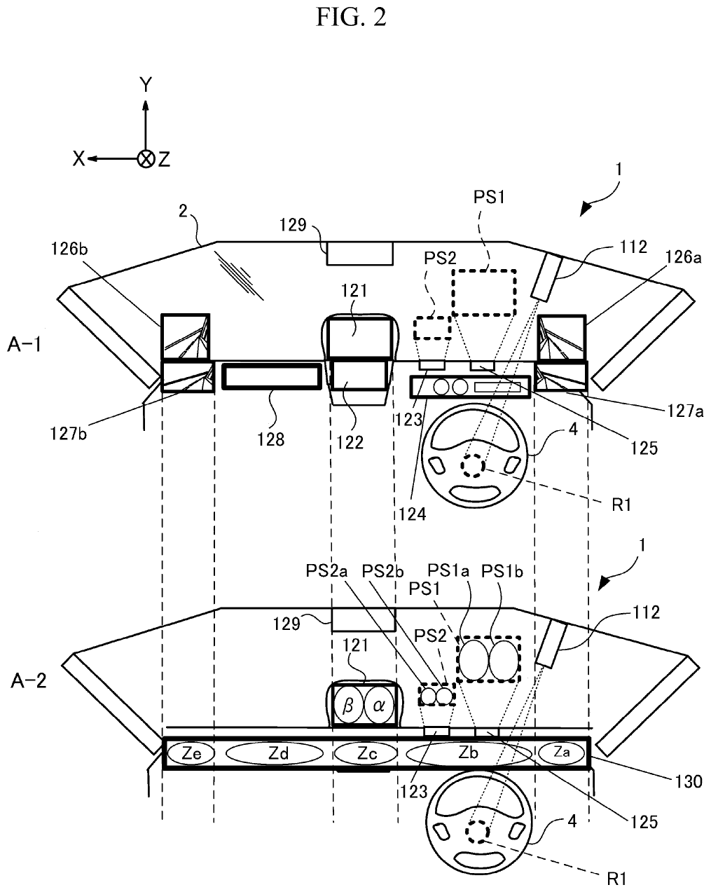

Next, the following refers to FIG. 2. FIG. 2 illustrates an example of a display unit (display device) usable in the present invention. In FIG. 2, the portion being the same as the counterpart in FIG. 1 is assigned the same reference numeral.

As indicated by A-1 in FIG. 2, examples of the display unit (display device) usable in the present invention can include the head-up display (HUD) device 125, a meter display 124, a WSD 123 as a direct projection display which projects the image displayed on the display onto a windshield or a screen without use of an optical system, the center information display (CID) 122, a center console monitor 121, passenger display 128, display mirrors (electronic side mirrors) 126a, 126b, side monitors 127a, 127b, and in-vehicle projector 112. Note that the reference numeral 129 indicates a rearview mirror.

By using various types of display units, i.e., display devices, included in the vehicle 1, the above-described various types of display control processes can be effectively performed without addition of any special display device.

As indicated by A-2 in FIG. 2, when a single display device includes a plurality of display areas whose display is separably controllable, the control unit 113 may perform the later-described display control process by deeming each single display area as a single display unit. By doing so, the number of usable display units can be substantially increased.

In A-2 in FIG. 2, the imaginary display surface PS1 in the HUD 125 is divided into two independent display areas PS1a, PS1b. The imaginary display surface PS2 in the WSD 123 is also divided into two independent display areas PS2a, PS2b.

The screen of the center console monitor 121 is divided into two independent display areas α, β. A wide display 130, elongating in the left-right direction and being a screen which is laterally long, is divided into five independent display areas Za to Ze.

By deeming that there is a display unit for each display area, the number of selectable display units increases, thereby allowing an optimal display unit to be selected and used. Accordingly, the visual effect for the occupant can enhance.

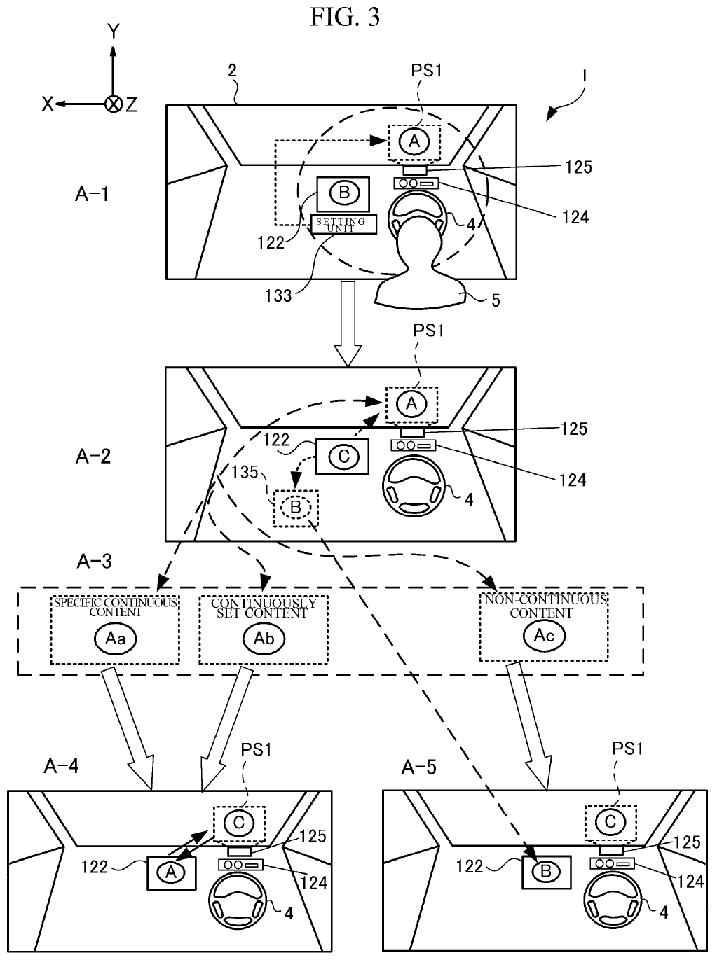

Next, the following refers to FIG. 3. FIG. 3 illustrates exemplary first to fourth display control processes. In FIG. 3, the portion being the same as the counterpart in any preceding figure is assigned the same reference numeral.

In the example of FIG. 3, the HUD device 125 is used as a first display unit (display device), and the center information display (CID) 122 is used as a second display unit (display device).

In A-1 in FIG. 3, the vehicle 1 is in the automatic driving state, and the HUD device 125 displays an image A such as entertainment content and an aerial map on the imaginary display surface PS1. For example, the entertainment content is content including an entertainment element which is unrelated to the driving operation, such as a television screen and a music playback screen. The aerial map provides a perspective map from above, as if overseeing the ground, and can also be rephrased as a bird's eye view or a panoramic view.

The occupant 5, to be a driver during manual driving, looks straight ahead and looks at the image A displayed on substantially front.

In addition, the CID 122 displays an image B, as navigation information assisting operation of the vehicle 1, for example.

Note that when the first image A currently watched is content desired to be continuously watched even after switching of the display, the occupant 5 operates the setting unit 133 in advance, to register the content as the continuously set content.

In A-1 in FIG. 3, the dashed ellipse indicates an area expected to be a field of view of the occupant 5. For example, when the occupant 5 visually confirms the image A in the frontal position, the direction of line of sight is uniquely identified. For example, the integrated control unit 104 of the control unit 113 can uniquely define the field of view according to a predetermined algorithm using the direction of line of sight as a center, and estimate it as the field of view of the occupant 5. In the following description, thus expected field of view is occasionally simply referred to as “field of view”.

Next, the following refers to A-2 in FIG. 3. For example, when the automatic driving segment on which the vehicle 1 travels is close to its end, automatic driving system issues a driving switching request (TOR), i.e., driving switching notification information.

In A-2 in FIG. 3, the image C about this driving switching notification information is displayed on the CID 122. In other words, while the occupant 5 on the vehicle 1 is watching the first image A on the HUD device 125, being the first display unit, when the vehicle 1 displays the image C about the driving switching notification information for notifying the occupant 5 that the first driving state (e.g., the automatic driving state) is switched to the second driving state (e.g., the manual driving state), the control unit 113 (refer to FIG. 1) performs the first display control process of causing to display the image C about the driving switching notification information, being the second image, on the CID 122, being the second display unit, instead of the image B displayed so far, in an attempt to prevent overlap with the first image A. Note that when there are a plurality of display units which can display the image C about the driving switching notification information within the range to be expected as the field of view (within the dashed ellipse) of the occupant 5, the integrated control unit 104 of the control unit 113 can select one display unit suited for displaying the image C about the driving switching notification information from thereamong. For example, in the example of A-1 in FIG. 3, the image C about the driving switching notification information can also be displayed on the meter display 124, for example. However, note that, although being separated from the first image A in an up-down direction when viewed from the occupant 5, the meter display 124 overlaps with the first image A in the left-right direction. Therefore, if the meter display 124 displays the image C about the driving switching notification information, the images will be arranged on top of each other vertically, which could be considered to give a somewhat complicated view. In view of this, in the example of A-1 in FIG. 3, the CID 122, which does not overlap with the first image A in any of the up-down direction or the left-right direction, and is located close to the occupant 5, displays the image C about the driving switching notification information. However, this is merely an example, and is not limiting.

The image B displayed on the CID 122, being the second display unit, is temporarily saved and stored in the memory 135.

Thereafter, as indicated by A-3 and A-4, the image A is replaced with the image C. In other words, the control unit 113 controls the HUD device 125, being the first display unit, and performs the second display control process of causing to display the image C about the driving switching notification information on the imaginary display surface PS1, instead of the first image A.

In this way, in switching of the driving state, instead of abruptly displaying the image C about the driving switching notification information in place of the first image A which the occupant 5 is watching, the image C about the driving switching notification information is displayed not to overlap with the first image A, to begin with. By doing so, the occupant 5 can recognize the image C about the driving switching notification information around his or her field of view while watching the first image A. Therefore, necessity of switching of the driving state can be notified, i.e., preliminary announced, to the occupant 5 without making the occupant 5 feel any discomfort.

Thereafter, the image C about the driving switching notification information is transitioned to the position at which the first image A used to be displayed. This assuredly notifies the occupant 5 of detailed content of driving switching and switching timing, etc., for example.

The above-described first and second display control processes are performed prior to expiry of the switching period of the driving state. In other words, in such a case where the automatic driving state is switched to the manual driving state in response to ending of the automatic driving segment, for example, notification by the driving switching notification information may be performed prior to expiry of the switching period of the driving state, and there may well be the case where there is comparatively a long time before the expiry of the switching period.

In the automatic driving segment, such a case may be considered in which an entertainment image, a map image, or the like, is displayed in the position where the occupant looks in front, i.e., the position where the occupant looks straight ahead, or in the vicinity thereof, and the occupant is visually confirming these images.

The mentioned display can be realized by display using a projection-type display device such as a head-up display (HUD) 125, which projects an image on a windshield or a screen covering a part of the windshield, for example. In this case, the image about the driving switching notification information can be displayed larger, for example, at the substantially front position as viewed from the occupant, which realizes an easy-to-view display.

On the other hand, in many cases, the vehicle 1 is provided with a display device, such as a center information display (CID) 122, which is either embedded in the dashboard 120 or provided upright on the dashboard 120, for example, in addition to the HUD device 125, or the like. The CID 122, or the like, is provided in the vicinity of the occupant 5 in many cases. Therefore, while watching an image displayed on the HUD 125, or the like, the occupant 5 can grasp an image displayed on the CID 122, or the like, in the periphery of the field of view.

With this in view, a first-type display device of projection type, which projects an image, such as the HUD 125, and a second-type display device of screen display type, which directly displays an image on a screen, such as the CID 122, are linked together, and the image C about the driving switching notification information is first displayed on the display device 122 of screen display type. In this case, while watching the first image A, the occupant 5 can notice that the image C about the driving switching notification information is presented in the periphery of his or her field of view and indirectly understand that switching of the driving state is to be performed.

Thereafter, the HUD 125, or the like, displays the image about the driving switching notification information, and displays the image C about the driving switching notification information in place of the first image A. By doing so, the occupant 5 can directly visually confirm the image about the driving switching notification information on the easy-to-view display without looking away, which allows the occupant 5 to assuredly recognize and confirm the content, timing, etc. of driving switching.

In this way, by cooperative control by way of linking together a plurality of display devices, i.e., a plurality of display units, in switching of the driving state, the occupant 5's feeling of distress is alleviated, and the occupant 5 can be made to recognize switching of the driving state without feeling any discomfort.

The first display unit 125 described above can be rephrased as a display unit which is at the position in which the level of looking away of the occupant 5 in the left-right direction is the smallest. The second display unit 122 can be rephrased as a display unit which is at the position in which the level of looking away of the occupant 5 in the left-right direction is larger than the case of the first display unit 125, for example, but which is within the range of the field of view (visibility) of the occupant 5 who is watching the image displayed by the first display unit 125, and which is comparatively close to the occupant 5 and whose display image can be recognized by the occupant 5.

Next, the following describes a case in which the first image A is continuously displayed even after the display switching and a case in which the first image A is not continuously displayed after the display switching.

In A-3 in FIG. 3, the control unit 113 determines whether the image A being watched by the occupant 5 is the predetermined continuous content Aa which is expected to be desired by the occupant to watch 5 or the continuously set content Ab set in advance as content desired to be continuously watched by the occupant 5, or any other non-continuous content Ac.

If the image A is continuous content Aa or continuously set content Ab, as indicated by A-4, the image A is transferred to the position of the image C, concurrently with transferring of the image C to the position of the image A. In other words, the image A and the image C are swapped. This swapping is indicated by the mutual arrows in A-2 in FIG. 3. The above-described control performed by the control unit 113 is referred to as a third display control process.

The third display control process is performed concurrently with the second display control process. As a result, the display of the first image A and the image C about the driving switching notification information are swapped. Because the first image A is continuously displayed in the second display unit 122, the occupant 5 can continuously watch the first image A at an appropriate timing even after switching of the display. In addition, because the first image A and the image C about the driving switching notification information are concurrently swapped, it does not take time, and the occupant experiences no visual discomfort but only minimal psychological burden.

In this way, in switching of the driving state, the occupant can be made to recognize switching of the driving state without feeling any discomfort while making sure not going against the expectations of the occupant.

In addition, as illustrated on the right side of A-3 in FIG. 3, when the first image is neither specific continuous content Aa nor continuously set content Ab, in other words, when the first image is non-continuous content Ac, the image B, which used to be displayed in A-1, is displayed again in the second display unit 122, as indicated by A-4 in FIG. 3. This display control performed by the control unit 113 is referred to as a fourth display control process.

Accordingly, the occupant 5 can watch again the image B, the display of which was discontinued by the presentation of the driving switching notification information. The occupant 5 can obtain useful information again from the image B.

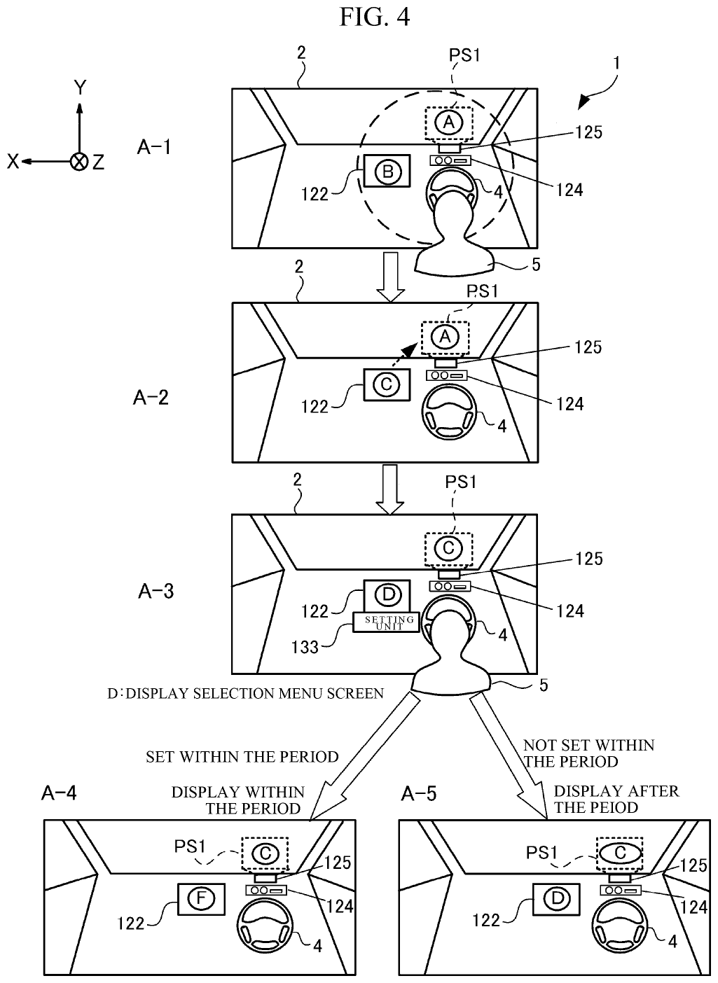

Next, the following refers to FIG. 4. FIG. 4 illustrates exemplary fifth and sixth display control processes. In FIG. 4, the portion being the same as the counterpart in any preceding figure is assigned the same reference numeral.

A-1, A-2 in FIG. 4 are the same as A-1, A-2 in FIG. 3. In A-3 in FIG. 4, when the first image A is non-continuous content, the control unit 113 causes the second display unit 122 to display content selection image D.

Then, the control unit 113 refers to the content selection image D within a predetermined period. For example when the content to be displayed next is selected by operating the setting unit 133, the image F of that selected content is displayed in the second display unit 122, as indicated by A-3 in FIG. 4. This display control is referred to as a fifth display control process.

Accordingly, content to be displayed on the second display unit 122 can be selected by the occupant 5. When the occupant 5 has selected content within a predetermined period, for example within a driving switching period (i.e., until the expiry of automatic driving period), the selected content F is displayed on the second display unit 122. Accordingly, the occupant 5 can watch a content image which the occupant 5 prefers, which improves the usability.

If no content selection is performed within a predetermined period, as indicated byA-4 in FIG. 4, the control unit 113 may perform display control to maintain the content selection image D even after the predetermined period. This display control is referred to as a sixth display control process.

Accordingly, even after the elapse of the predetermined period, the content selection image D is maintained in the second display unit 122. Accordingly, even after the elapse of the predetermined period, the occupant 5 can select content to be displayed on the second display unit 122 as appropriate when there is time, which improves the usability.

Note that an operation method when predetermined content is selected may be any of an operation by buttons, a touch operation for a display panel, an audio operation by way of vocalization, or an operation by way of gesture.

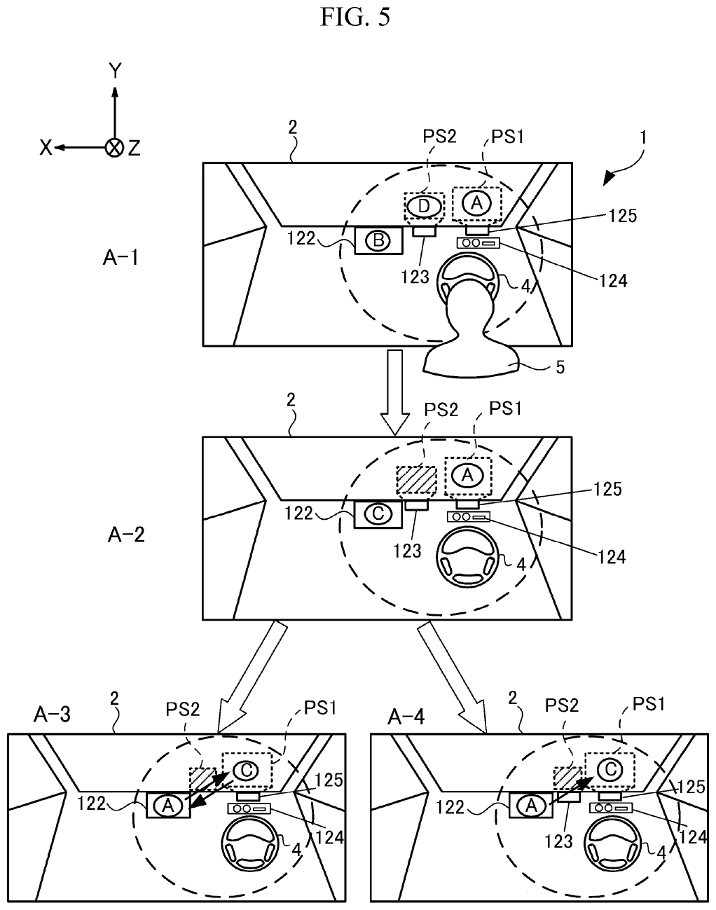

Next, the following refers to FIG. 5. FIG. 5 illustrates an exemplary seventh display control process. In FIG. 5, the portion being the same as the counterpart in any preceding figure is assigned the same reference numeral.

In the example of FIG. 5, in addition to the first and second display units 125, 122, there is an other display unit, i.e., a third display unit 123. The WSD, being the third display unit 123, causes the image D to be displayed on the imaginary display surface PS2.

Here, during a period in which the first display control process of causing to display the image C about the driving switching notification information on a screen of the second display unit 122 and the second display control process of causing to display the image C on the imaginary display surface PS1 by the first display unit 125 are performed, a display control process of decreasing the visual attraction of the display image on the third display unit 123, being the other display unit, is performed. This display control is referred to as a seventh display control process.

In the seventh display control process, any of the following may be performed: the visual attraction is decreased by lowering the luminance, chroma, or brightness of the display; the visual attraction is decreased by providing a translucent mask on the display image surface; the display is hidden; or an auxiliary image which indicates switching of the driving state is displayed, for example.

In other words, for any other display unit other than the display unit on which the display is changed, any of the following control may be performed: the luminance, chroma, or brightness of the display is lowered to a predetermined value; a translucent black mask is provided on the display screen; the display is turned off; or an auxiliary image, such as texts or animation, which indicates switching of the driving state, is displayed, so as to make the occupant 5 focus on the display unit on which the display is changed.

Accordingly, the occupant 5 is prevented from being distracted and can focus on the content subject to display switch, which ensures reliable presentation of information.

In A-2 in FIG. 5, for the image D, the luminance of the display is sufficiently lowered, and the image D is in a state in which visual confirmation is difficult. Thereafter, the control transitions to either A-3 or A-4 in FIG. 5. Here, A-3 and A-4 in FIG. 5 are not described, because of corresponding to A-4 and A-5 in FIG. 3, which were described earlier.

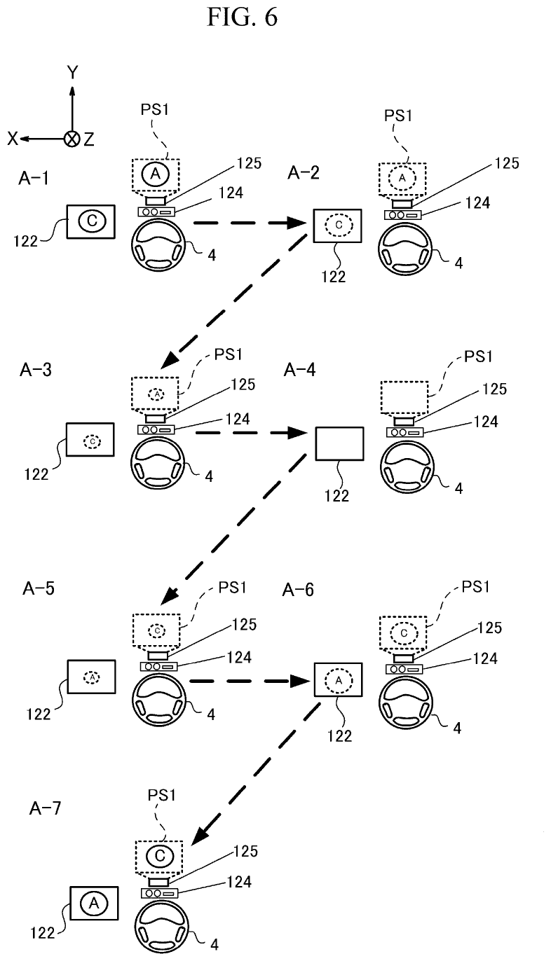

Next, the following refers to FIG. 6. FIG. 6 illustrates an exemplary display in a case where fade-out and fade-in are used as a method of disappearance and appearance of an image, during switching of a display. In FIG. 6, the portion being the same as the counterpart in any preceding figure is assigned the same reference numeral.

The example of FIG. 6 illustrates an exemplary change of a display mode in a process of swapping the image C about the driving switching notification information and the first image A, described earlier in A-4 in FIG. 2. In A-1 to A-4 in FIG. 6, fade-out processing to make the display images A and C gradually disappear on the first and second display units over time is performed.

In A-5 to A-7 in FIG. 6, fade-in processing to make the display images C and A gradually appear on the first and second display units over time is performed.

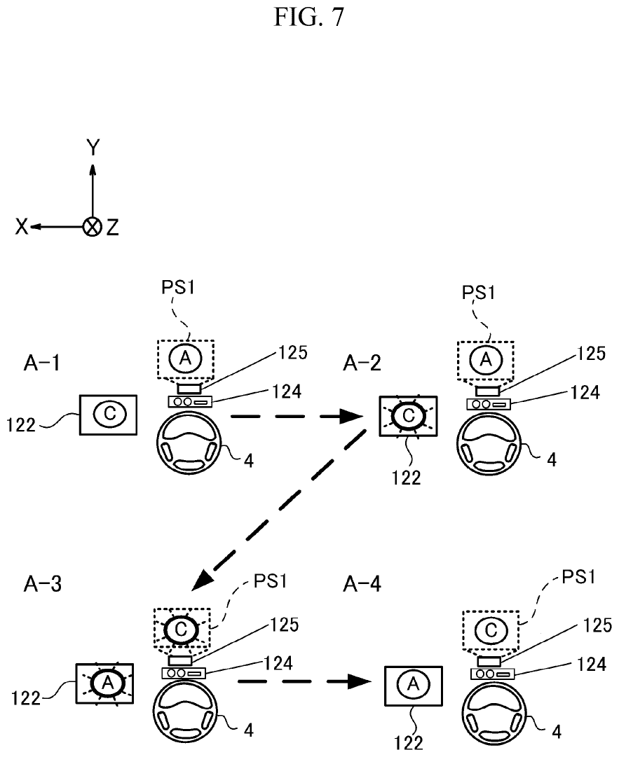

Next, the following refers to FIG. 7. FIG. 7 illustrates an exemplary display in a case where a highlighting display system is used as a method of disappearance and appearance of an image, during switching of a display.

In the example of FIG. 7, highlighting display is performed. Highlighting display can be said to be a process to flash the display image, to change the colors, or the like, to temporarily change the image size, or to add characters, icons, etc., in order to change the visual attraction.

The example of FIG. 7 illustrates an exemplary change of a display mode in a process of swapping the image C about the driving switching notification information and the first image A, described earlier in A-4 in FIG. 2.

In A-1 in FIG. 7, the image C about the driving switching notification information is displayed, and in a predetermined period immediately following, a highlighting display process of repeating flashing several times is performed on the image C, as indicated by A-2 in FIG. 7.

Subsequently, in A-3 in FIG. 7, the first image A and the image C about the driving switching notification information are swapped. In a predetermined period immediately following the swapping, the image A and the image C are both subjected to the highlighting display process. When the predetermined period has elapsed, the highlighting display is cancelled to return to a normal display, as indicated by A-4 in FIG. 7.

In this way, when switching the image display, the control unit 113 may perform an instantaneous image disappearance and appearance process, as indicated by A-4 in FIG. 3, as a method of disappearance of an image and a method of appearance of an image in the display switching period, in at least one of the first and second display units 125 and 122. Alternatively, as indicated in the example of FIG. 6, the disappearance and appearance process using the fade-out and fade-in to change the luminance over time may be performed.

Still alternatively, as indicated in the example of FIG. 7, the disappearance and appearance process involving a highlighting process by way of flashing of an image or change of a display mode may be performed.

By devising the method of disappearance and appearance of an image during switching of a display, visual attraction can be enhanced. This helps the occupant focus on the display unit on which the display is changed.

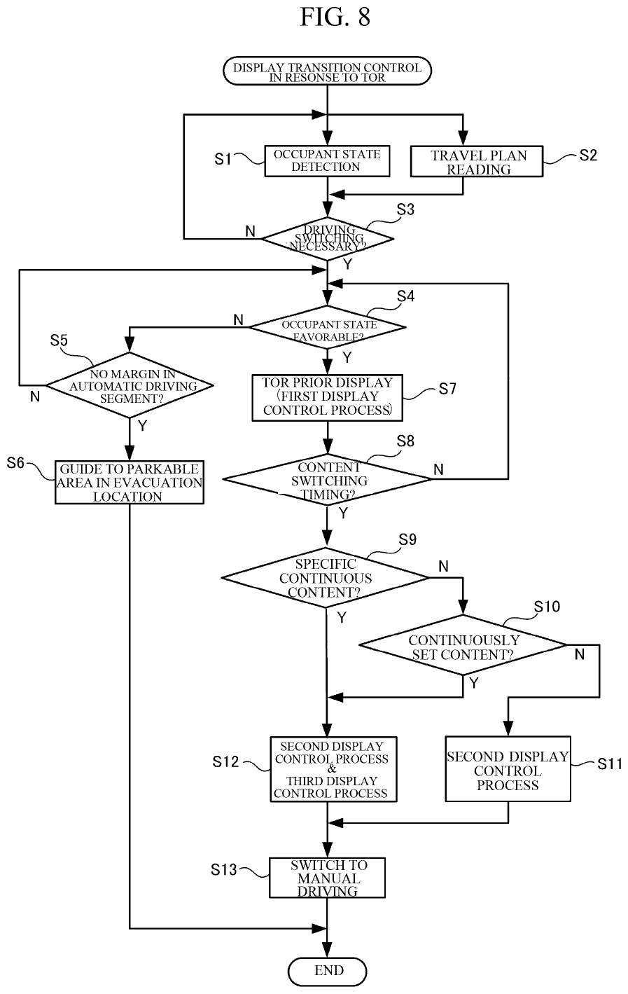

Next, the following refers to FIG. 8. FIG. 8 is a flowchart illustrating an example of display control in response to a driving switching request.

The following describes a case in which automatic driving is switched to manual driving in an automatic drivable vehicle. In FIG. 8, steps S1 to S13 are performed prior to completely switching from automatic driving to manual driving.

In step S1, the driving state monitoring unit 15 (refer to FIG. 1) detects the state of the occupant 5. In step S2, the AI module 14 (refer to FIG. 1) reads a travel plan. The travel plan is, for example, a plan to decide up to where in the automatic driving segment the traveling should be performed, and is decided in advance prior to starting of this traveling in the automatic driving segment.

In step S3, for example, the AI module 14 determines whether switching from automatic driving to manual driving is necessary. This determination can be performed, for example, by determining whether the path traveled has reached a predetermined distance (e.g., 10 km) from the point at which the automatic driving segment is switched to a manual driving segment. The determination may be performed using time, instead of distance. However, this is merely an example, and is not limiting. For example, ending of the automatic driving segment may be notified a plurality of number of times in some cases. In that case, there may be cases in which the driving switching notification information is issued at a point in time substantially prior to the expiry timing of the automatic driving segment.

When driving switching is unnecessary, the control returns to steps S1, S2, and when driving switching is necessary, the control proceeds to step S4.

In step S4, it is determined whether the state of the occupant is favorable. In other words, the occupant state determining unit 111 (refer to FIG. 1) determines whether the occupant 5 is in a state in which information provided by a collection of various types of display units (display unit group) can be received.

For example, an image captured by the image-capturing camera 114 is image-analyzed in the image analysis unit 110. Based on the analysis result, the driving state monitoring unit 15, for example, of the occupant state determining unit 111 calculates the arousal and forward attention level of the occupant 5. The driving state estimating unit 13, for example, calculates the driving suitability of the occupant 5, based on the plurality of calculated elements. If the calculated driving suitability achieves a predetermined threshold, i.e., if Y in step S4, the control transitions to step S7; and if not, i.e., if N in step S4, the control transitions to step S5.

In step S5, it is determined whether there is no sufficient margin in the automatic driving segment. Whether there is a sufficient margin or not can be determined by determining whether the distance up to the end point of the automatic driving segment is a predetermined threshold or more. If there is a sufficient margin, i.e., if N in step S5, the control returns to step S4. If there is no sufficient margin, i.e., if Y in step S5, the control transitions to step S6. In step S6, the driving assistance system (automatic driving system) 10 guides the vehicle 1 to an evacuation location such as a service area or a parking area, and stops the vehicle 1.

If Y in step S4, the control transitions to step S7. In step S7, the image about a takeover request (TOR: a type of driving switching request) is displayed on the second display unit 122, for example, as described earlier. This display is displayed as a preliminary announcement to the occupant 5, prior to switching of the driving state, and which can also be referred to as a prior display or a preliminary announcement display.

Note that if an image has been displayed on the second display unit 122, instead of that image, an image about TOR is displayed on the second display unit 122. In other words, the first display control process is performed.

In step S8, it is determined whether it is a content switching timing. To be more specific, it is determined whether the point at which the content is transitioned has reached. This point is determined, in advance, before the ending point of the automatic driving segment is reached, and taking into consideration the time for the occupant to be able to prepare for manual driving both psychologically and physiologically.

Note that this point may be decided from the distance from the ending point of the automatic driving segment (e.g., 1 km), in addition to the time from the ending point of the automatic driving segment (e.g., 5 minutes).

When the content transition point has not reached, i.e., if N in step S8, the control returns to step S4. If Y in step S8, the control transitions to step S9.

Note that if a cycle of step S4, step S7, step S8, step S4 . . . is repeated until reaching the content transition point, the display of the image on the second display unit 122 is maintained.

In step S9, the first image displayed on the first display unit 125 is specific continuous content. This determination is performed by the integrated control unit 104 of the control unit 113, for example. Note that the specific continuous content may be predetermined entertainment content, an aerial map useful for the vehicle operation, or the like.

If N in step S9, the control transitions to step S10. In step S10, it is determined whether the first image displayed on the first display unit 125 is continuously set content. If Y in step S10, and if Y in step S9 described earlier, the second display control process, which transitions the image about TOR to the first display unit 125 for switching images, and the third display control process, which transitions the first image to the second display unit 122 for switching images, are performed concurrently with each other.

On the other hand, if N in step S10, the control transitions to step S11. In step S11, only the second display control process is performed.

In step S13, the driving state of the vehicle 1 is switched to manual driving.

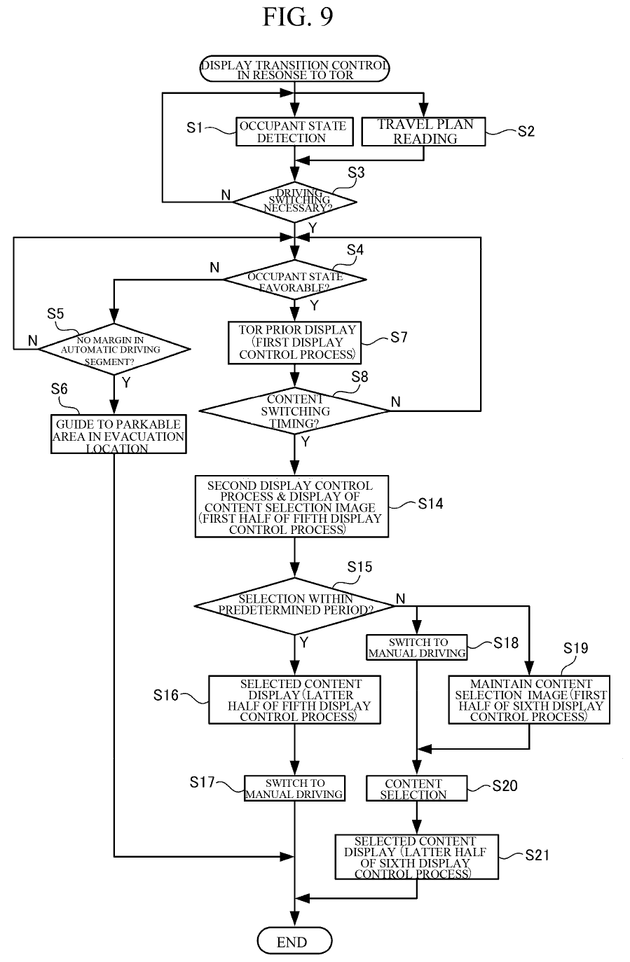

Next, the following refers to FIG. 9. FIG. 9 is a flowchart illustrating an other example of display control in response to a driving switching request. In FIG. 9, step S1 to S8 are the same as their counterparts in FIG. 8, and therefore the description is omitted for them.

In step S14, the second display control process, which transitions the image about TOR to the first display unit 125 for switching images, and display of the content selection image (content selection screen) on the second display unit 122 are performed. The display of the content selection image corresponds to a first half of the fifth display control process.

In step S15, it is determined whether the occupant has selected display content within a predetermined period. If Y in step S15, the control transitions to step S16.

In step S16, the selected content is displayed. This corresponds to a latter half of the fifth display control process.

In step S17, switching is performed to manual driving.

If N in step S15, the control transitions to step S18 and step S19. In step S18, switching is performed to automatic driving. In step S19, display of the content selection image (content selection screen) is maintained. This corresponds to a first half of the sixth display control process.

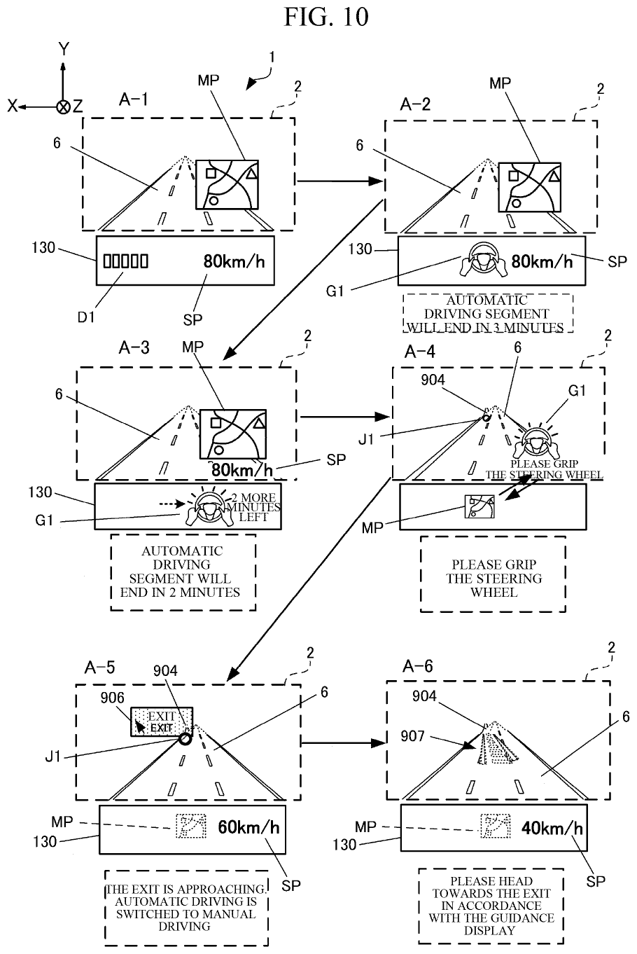

Thereafter, in step S20, when the occupant has selected content, in step S21, the selected content is displayed. This corresponds to a latter half of the sixth display control process. Next, the following refers to FIG. 10. FIG. 10 illustrates a concrete example of display control in a vehicle traveling along a highway.

In A-1 in FIG. 10, the vehicle 1 is traveling along a road surface 6 of a highway in an automatic driving mode. An aerial map (map information) MP is displayed on the windshield 2 by the HUD device 125 being first display unit.

In addition, a remaining fuel display D1 and a vehicle speed display SP are displayed on the wide display 130, for example.

In A-2 in FIG. 10, the occupant is notified of the ending of the automatic driving segment by means of a guiding audio, for example, announcing “the automatic driving segment will end in 3 minutes”. At the same time, the wide display 130, being the second display unit, displays an icon image G1, being driving switching notification information, indicating that the occupant will grip the steering wheel. This display control corresponds to the first display control process.

At this time, the remaining fuel display D1 is hidden. This corresponds to the seventh display control process. However, the vehicle speed display SP is maintained.

In A-3 in FIG. 10, the occupant is notified of the ending of the automatic driving segment by means of a guiding audio announcing “the automatic driving segment will end in 2 minutes”.

Concurrently with this process, the position of the icon image G1 displayed in A-2 in FIG. 10 is moved in the right direction (the direction approaching the steering wheel). This facilitates grasping of the icon image G1 in the center portion in the occupant's field of view. In addition, the vehicle speed display SP is displayed in the lower side of the aerial map MP by the HUD device 125. In other words, the display position of the vehicle speed display SP is changed from the wide display 130 to the imaginary display surface realized by the HUD device 125.

In A-4 in FIG. 10, the occupant is prompted to grip the steering wheel by means of a guiding audio indicating “please grip the steering wheel”.

In addition, the second display control process, which transitions the icon image G1 to the position at which the aerial map MP used to be displayed, is performed, and concurrently with this process, the third display control process, which transitions the aerial map MP to the position at which the icon image G1 used to be displayed, is performed.

Here, the transitioned icon image G1 is assigned letters indicating “please grip the steering wheel”, in which such message that the display mode is changed and it is the timing to grip the steering wheel is more emphasized. Such modification, or application can be made wherever appropriate.

In addition, as described earlier, the display position of the icon image G1 has moved in A-2 in FIG. 10. Thereafter, the second display control process of moving to the position at which the aerial map MP used to be displayed was performed thereon.

In other words, in the second display control process, a display moving process of gradually moving to the position at which the aerial map MP used to be displayed, over time, is performed on the icon image G1, being driving switching notification information. Accordingly, it is possible to impress on the occupant the change in the display content, for example, which ensures more reliable presentation of information.

Note that in the above-described example, the display switching is performed after moving the display position of the driving switching notification information in the display unit (wide display 130) having a laterally long display screen. However, the driving switching notification information may be moved by switching the display on which the driving switching notification information is to be displayed. Alternatively, the movement may be performed using a display movable (movable display) in the left-right direction. It is also possible to perform the movement control using the in-vehicle projector 112.

In A-5 in FIG. 10, an exit 904 and an exit guide 906 are visible on the left side in front of the vehicle 1. In addition, a highlighting image J1 highlighting the exit 904 is displayed by the HUD device 125, for example.

In addition, a guiding audio announcing “The exit is approaching. Automatic driving is switched to manual driving” notifies that transitioning to manual driving has been performed.

In addition, on the wide display 130, the luminance of the aerial map MP is lowered so that the occupant can focus on the driving operation towards the exit 904. In addition, since the vehicle speed information is information necessary for the driving operation, the vehicle speed display SP is displayed again. Such modification, or application of the display can be made wherever appropriate.

In A-6 in FIG. 10, a guidance display (road surface overlay display) 907 towards the exit is displayed. In addition, a guiding audio prompting “Please head towards the exit in accordance with the guidance display” is issued by the driving assistance system 10. On the wide display 130, the display of the aerial map MP with lowered luminance and the vehicle speed display SP is maintained.

As described so far, the present invention can make the occupant recognize switching of the driving state without feeling any discomfort, while alleviating the occupant's feeling of distress or not going against the expectations of the occupant in switching of the driving state.

Various modifications and applications can be made with respect to the present invention. For example, the driving switching notification information is not limited to the case exemplified in the above-described embodiment, and various display modes can be adopted therefor, as appropriate.

In addition, the term “vehicle” in the present specification can also be broadly interpreted to include any mode of transportation. Similarly, terminology related to navigation should be interpreted broadly. Additionally, the scope of the invention encompasses HUD devices, display tool apparatuses, display units, and display systems, which may also be used as simulators (such as flight simulators or gaming devices as simulators).

The present invention extends beyond the exemplary embodiments described above, allowing for easy modifications within the scope of patent claims.

### DESCRIPTION OF REFERENCE NUMERALS

1 . . . vehicle (own vehicle)
2 . . . windshield (projected member)
4 . . . steering wheel
10 . . . driving assistance system (automatic driving system)
12 . . . information collecting unit
13 . . . driving state estimating unit
14. . . . AI module
15 . . . driving state monitoring unit
16 . . . speed control module
18 . . . steering control module
102 . . . display control device (processor)
104 . . . integrated control unit
105 . . . audio guiding unit
107 . . . display tool control unit
108. . . . HUD and WSD control unit
109 . . . in-vehicle projector control unit
110 . . . image analysis unit
111 . . . occupant state determining unit
112 . . . in-vehicle projector
114 . . . image-capturing camera
120 . . . dashboard
125. . . . HUD device (first display unit)
121 . . . center console monitor
122 . . . center information display (CID: second display unit)
123 . . . direct projection display for projection onto windshield or screen without use of optical system (WSD)
124 . . . meter display
126 (126a, 126b) . . . display mirror
127 (127a, 127b) . . . side monitor
128 . . . passenger display
130 . . . wide display
133 . . . setting unit
135 . . . memory
A . . . first image
C . . . driving switching notification information (image about driving switching notification information, second image)
D . . . content selection image (content selection screen)
F . . . image of selected content
PS . . . imaginary display surface

1. A display control device including:
a control unit to control image display of a plurality of display units mounted on a vehicle, wherein
the plurality of display units include a first display unit to display a first image and a second display unit to display a second image, and
in displaying driving switching notification information for notifying an occupant of the vehicle of switching of the vehicle from a first driving state to a second driving state, in a state in which the occupant watches the first image on the first display unit, the control unit performs:
a first display control process of causing the second display unit to display the driving switching notification information, being the second image, so as not to overlap with the first image; and thereafter
a second display control process of causing the first display unit to display the driving switching notification information instead of the first image.

2. The display control device according to claim 1, wherein
the first display unit is a projection-type display device to project display light of an image onto a windshield of the vehicle or a screen provided to cover at least a part of the windshield,
the second display unit is a display tool apparatus to display an image on a display screen, and
the control unit performs the first and second display control processes prior to expiry of a driving state switching period.

3. The display control device according to claim 1, wherein
if the first image is predetermined continuous content which is expected to be desired by the occupant to continuously watch, or continuously set content set in advance as content desired to be continuously watched by the occupant, the control unit performs, concurrently with the second display control process, a third display control process of causing the first image to be displayed as the second image on the second display unit.

4. The display control device according to claim 1, wherein
if the first image is neither predetermined continuous content which is expected to be desired by the occupant to continuously watch, nor continuously set content set in advance as content desired to be continuously watched by the occupant, the control unit performs a fourth display control process of causing the second display unit to display, again, content which the second display unit used to display prior to displaying the driving switching notification information.

5. The display control device according to claim 1, wherein
if the first image is neither predetermined continuous content which is expected to be desired by the occupant to continuously watch, nor continuously set content set in advance as content desired to be continuously watched by the occupant, the control unit performs a fifth display control process in which a content selection image is displayed on the second display unit, and if content is selected using the content selection image within a predetermined period, the selected content is displayed on the second display unit.

6. The display control device according to claim 5, wherein
if the content is not selected within the predetermined period, the control unit performs a sixth display control process of maintaining the content selection image even after the predetermined period.

7. The display control device according to claim 1, wherein
if there is an other display unit in addition to the first and second display units, the control unit performs a seventh display control process of performing either:
decreasing visual attraction by lowering luminance, chroma, or brightness of display in the other display unit during a period in which the first and second display control processes are being performed;
decreasing visual attraction by providing a translucent mask on a display image surface;
hiding the display; or
displaying an auxiliary image which indicates driving state switching.

9. The display control device according to claim 1, wherein
as a method of disappearance of an image and a method of appearance of an image in a display switching period, the control unit performs, on at least one of the first and second display units, any of:
an instantaneous image disappearance and appearance process;
a disappearance and appearance process using fade-out and fade-in to change luminance over time; or
a disappearance and appearance process involving a highlighting process by way of flashing of an image or change of a display mode.

9. The display control device according to claim 1, wherein
the display unit is any display device from among a head-up display (HUD) device, a meter display, a direct projection display for projection of an image displayed on a display onto a windshield or a screen without use of an optical system, a center information display (CID), a center console monitor, a wide display, a passenger display, a display mirror, a side monitor, and an in-vehicle projector projecting an image inside the vehicle.

10. The display control device according to claim 1, wherein
when a single display device includes a plurality of display areas whose display is separably controllable, the control unit performs the first and second display control processes by deeming each single display area as a single display unit.

11. The display control device according to claim 1, wherein
the control unit performs, in the second display control process, a display moving process of moving the driving switching notification information over time, and thereafter transitioning the driving switching notification information to the first display unit.

12. A display system comprising:
a plurality of display units mounted on a vehicle; and
the control unit according to claim 1.

13. A display control method of controlling image display of a plurality of display units mounted of a vehicle,
the plurality of display units including a first display unit to display a first image and a second display unit to display a second image, and
in displaying driving switching notification information for notifying an occupant of the vehicle of switching of the vehicle from a first driving state to a second driving state, in a state in which the occupant watches the first image on the first display unit, the display control method comprising:
a step of performing a first display control process of causing the second display unit to display the driving switching notification information, being the second image, so as not to overlap with the first image; and thereafter
a step of performing a second display control process of transitioning the driving switching notification information to the first display unit, and displaying the driving switching notification information instead of the first image.
